(19) United States
(12) Patent Application Publication
(10) Pub. No.: US 2021/0387201 A1
(43) Pub. Date: Dec. 16, 2021

(54) ANNULAR-GAP MILL

(71) Applicant: BÜHLER AG, Uzwil (CH)

(72) Inventors: Cornel FRAEFEL, Flawil (CH); Achim Philipp STURM, Niederuzwil (CH); Pascal EGGER, Berg SG (CH); Eduard NATER, Zuckenriet (CH)

(21) Appl. No.: 17/291,779

(22) PCT Filed: Nov. 6, 2019
(86) PCT No.: PCT/EP2019/080356

§ 371 Date: May 6, 2021

(30) Foreign Application Priority Data
Nov. 9, 2018 (EP) 18 20 5435.3

(51) Int. Cl. B02C 17/16; B02C 17/18

(52) U.S. Cl. CPC B02C 17/166; B02C 17/18

(57) ABSTRACT

A generally cylindrical rotor (1) for an agitator mill is provided. The rotor has a rotor wall (11), a plurality of tools (13) attached to the rotor wall, a rotor separation ring (12), a rotor hub (14), and at least one connecting rod (15). The rotor (11) and the rotor separation ring (12) are clamped in the hub (14) by means of the connecting rods (15). The rotor separation ring (12) is designed as a rotationally symmetrical hollow cylinder. The rotor wall (11) is rotationally symmetrical with respect to an axis of rotation (19) and is mirror-symmetrical with respect to a plane of symmetry perpendicular to the axis of rotation. A mill comprising the rotor, a method for servicing the mill, and a stator assembly for use in a mill are also provided.

The invention relates to a rotor of an agitator mill, in particular an annular-gap mill.

Agitator mills have a broad spectrum of applications for milling and dispersion of solids in liquids. For example, they are used in the manufacture of adhesives, printing inks, cosmetics and pharmaceuticals. A common configuration is the annular-gap mill, in which, in a milling chamber between the rotor and a stator, and with the help of grinding bodies, dispersions are made. For that purpose milling tools, for example in the form of round pegs, can be attached to the rotor and/or to the stator. The material to be milled is passed into the milling chamber through an inlet duct, wherein it is milled and then discharged via a separating device that holds back the grinding bodies. The separating device is often a sieve but can also be in the form of a gap.

As a rule, annular-gap mills have a long product dwell time and show plug flow on the inside. Owing to drag forces, there are particularly numerous grinding bodies on the output side, as a result of which increased wear takes place both of the separating device and also of the stator, the rotor and the tools attached thereto. This leads to an asymmetrical abrasion of the components, which necessitates frequent replacement of certain assemblies.

Accordingly, the purpose of the present invention is to prolong the useful life of the said components, especially the rotor. According to the invention, this objective is achieved by the characteristics specified in the independent claims. The dependent claims describe embodiments of the invention.

By virtue of the invention, a generally cylindrical rotor for an agitator mill is provided. The rotor has a rotor wall, a plurality of tools attached to the rotor wall, a rotor separation ring, a rotor hub and at least one tie-rod. The rotor wall and the rotor separation ring are clamped into the hub by means of the tie-rods and are held together in that way. The rotor separation ring is in the form of a rotationally symmetrical hollow cylinder. The rotor wall is rotationally symmetrical relative to a rotation axis and mirror-symmetrical relative to a plane of symmetry perpendicular to the rotation axis. Preferably, this is also true of the arrangement of tools on the rotor wall. The rotor separating ring should be made of a very durable material such as ceramic, carbide metal, hardened metal or the like.

Furthermore, according to the invention, a mill for the treatment of flowable milled material with the rotor is provided. The mill also has a stator with a generally cylindrical inner stator wall, a product inlet and a product outlet. The rotor is arranged inside the stator so that a milling chamber is formed between an inner wall of the stator and the rotor. The milled material can get into the milling chamber through the product inlet and be discharged from the milling chamber through the product outlet. In addition, the mill comprises a stator separation ring, which preferably in essence forms a side surface of the milling chamber. Particularly preferably, the corresponding side surface of the milling chamber is formed completely by the stator separation ring. Preferably, together with the rotor separation ring, the stator separation ring forms the gap which serves to separate the milled material from the grinding bodies arranged in the milling chamber if necessary. The said gap is also called the separation gap. The stator separation ring is preferably in the form of a rotationally symmetrical hollow cylinder, and consists of ceramic, carbide metal or a hardened metal.

In an embodiment, the inner wall of the stator is also rotationally symmetrical relative to the rotation axis and mirror-symmetrical relative to the said plane of symmetry. If milling tools are also attached on the inside wall of the stator, the arrangement of these milling tools should also be rotationally symmetrical relative to the rotation axis and mirror-symmetrical relative to the said plane of symmetry.

According to an embodiment the milling gap width, i.e., the width of the milling chamber, is between 20 and 60 mm, the ratio of the stator's length to the inside diameter of the stator is between 2 and 4, and/or the ratio of the stator's length to the milling gap width 15 to 30.

If any mill components are worn, the symmetrically configured components can then be rotated and inserted again, during a mill servicing operation, and can therefore be used further. This can happen by virtue of the method according to the invention for servicing a mill. Thus, the useful life of such components, in particular the rotor, the stator and the rotor and stator separation rings can be extended.

Further features, advantages and details emerge from the attached figures, in which the same indexes denote the same or similar elements. The figures show:

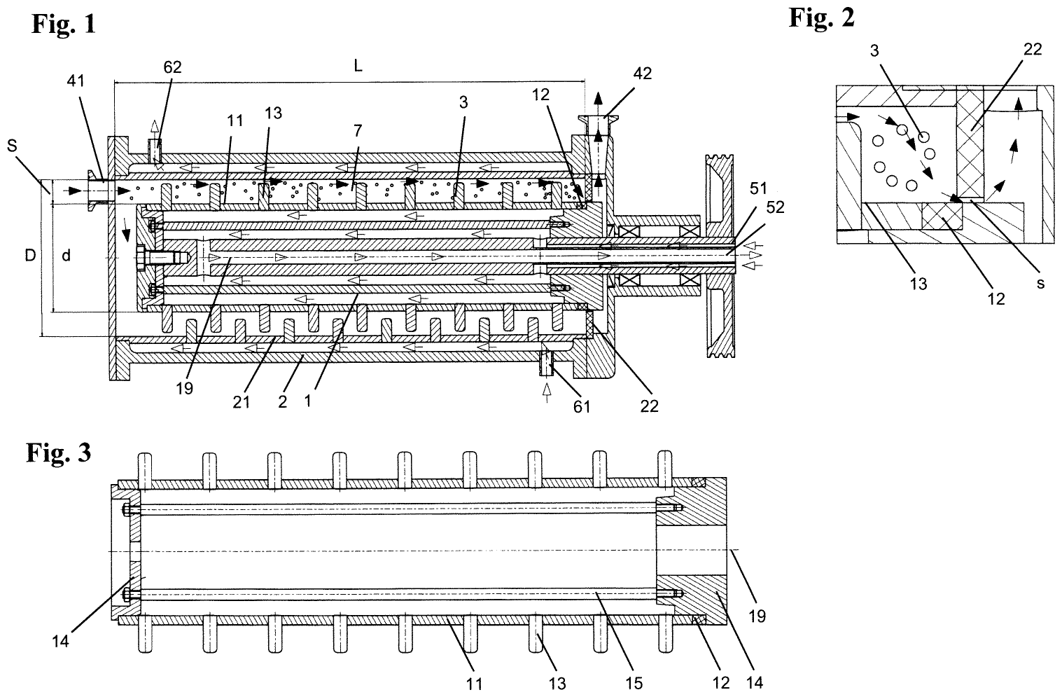

FIG. 1: An annular-gap mill according to an embodiment of the present invention,

FIG. 2: A sectioned view of the separation gap of the annular-gap mill in FIG. 1, with its rotor and stator rings, and

FIG. 3: The rotor assembly of the annular-gap mill in FIG. 1.

The annular-gap mill, shown in FIG. 1, comprises in the usual way a milling chamber 7, which is formed between an inner stator wall 21 and a rotor wall 11 of a rotor 1. The rotor 1 is mounted to rotate about a central longitudinal axis 19. Milling tools 13, which project into the milling chamber 7, can be attached on the rotor wall 11. The milling tools 13 can be, for example, in the form of round pegs, although other shapes too can serve this purpose. Optionally, milling tools can also be attached on the inside wall 21 of the stator.

The product enters the milling chamber 7 through a product inlet 41, in which chamber it is dispersed or milled with the help of grinding bodies 3. The product flow is indicated by dark arrows. On the discharge side, separation rings 12, 22 are attached to both the rotor 1 and the stator 2 to prevent grinding bodies 3 from making their way to the product outlet 42 together with the finished product. These form a gap s, the size of which is chosen such that the grinding bodies 3 cannot escape from the milling chamber 7. Thus, in particular the gap s or separation gap is smaller than the diameter of the grinding bodies 3 used. For example, if grinding bodies with a typical diameter of 2 mm are used, then the separation gap s should be made smaller, for example, 1 mm. A similar ratio should apply with grinding bodies of different size, wherein the diameter of the grinding bodies can vary between a few microns and up to several millimeters depending on the application and the mill used.

The separation device with its gap s, also called the separation gap, is shown in FIG. 2. The separation rings 12, 22 are, in this case, preferably made from a very durable material such as ceramic, hardened metal, carbide metal or the like. Owing to the drag forces produced during milling, the concentration of grinding bodies 3 at the separation device formed by the rotor separation ring 12 and the stator separation ring 22 is particularly high. This results in high wear of the separation rings 12, 22 and of the rows of milling tools 13 positioned on the rotor in the vicinity of the separating device, the milling tools sometimes arranged on the inside wall 21 of the stator, and the inside wall surfaces of the rotor and stator on the outlet side. In particular, this affects the first two to three rows of milling tools arranged closest to the separating device and sides of the rotor separation ring 12 and stator separation ring 22 facing toward the milling chamber 7.

Since the wear takes place on one side and therefore asymmetrically, owing to the structure of conventional mills, it is also necessary to replace components in which the side remote from the separation gap s is worn only slightly or even not at all. To be able to use the components affected more intensely by wear, namely, the rotor wall 11, the inside stator wall 21, the rotor separation ring 12 and the stator separation ring 22, for a longer time, according to the present invention these are configured symmetrically. In particular, the rotor wall 11 with the tools 13 attached to it is formed rotationally symmetrically and symmetrically relative to a plane of symmetry or section plane perpendicular to the rotation axis 19. Moreover, the inside wall 21 of the stator with any tools arranged on it is designed such that after being rotated through 180° perpendicularly to the rotation axis 19 it can be fitted in again. Thus, the stator 2 with its inside stator wall 21 is in the form of a stator assembly which is arranged between the cover and an outlet flange of the agitation mill and is formed and defined thereby. In this case, the cover is arranged on the product inlet side of the agitation mill and the outlet flange on the product outlet side, but these are only terminological expressions and not structural definitions. The inside wall 21 of the stator is also mirror-symmetrical relative to said section plane perpendicular to the rotation axis 19. The rotor separation ring 12 and the stator separation ring 22 are in the form of rotationally symmetrical hollow cylinders. These too can, therefore, be rotated and fitted in again.

In that way, when wear has taken place the unit can be disassembled and the affected components, namely, the rotor 1, the stator 2, the rotor separation ring 12 and the stator separation ring 22, can be turned round and used again. This can double the useful life of the components concerned and thus, by comparison with conventional units, it enables substantially longer lasting use.

Finally, FIG. 3 shows the structure of the rotor assembly of FIG. 1. This can be supplied as a preassembled rotor assembly, which facilitates replacement. According to the embodiment shown, the rotor assembly 1 consists of the rotor wall 11 with the milling tools 13 attached to it, and the rotor separation ring 12. These components are fixed onto a hub 14 and are held together by at least one tie-rod 15. The tie-rods 15 clamp together opposite parts of the hub 14, between which the rotor wall 11 and the rotor separation ring 12 are inserted, and thus serve as axial clamping means. Thus, by releasing the at least one tie-rod 15, the entire assembly can be disassembled very simply and owing to the symmetrical structure of the rotor wall 11 with its milling tools 13 and that of the rotor separation ring 12, it can be turned around and reassembled in the event of non-uniform wear. Clamping means other than tie-rods may also serve the purpose.

A test to see if the rotor 1 is leak-proof can be applied to the preassembled assembly.

Owing to the generation of heat during milling, both the rotor 1 and the stator 2 can be cooled in order to reduce the load on the components and thus also the wear. For this, a coolant can be passed through the coolant inlet 51, 61 to the inside of the rotor 1 and the stator 2. Once heat exchange has taken place, the coolant is discharged from the rotor 1 and stator 2 through the coolant outlet 52, 62 and returned to the coolant circuit. In FIG. 1, the coolant flow is indicated by the light arrows. The coolant inlet 61 of the stator and the coolant outlet 62 of the stator can be arranged, respectively, on opposite ends of the stator and offset by 180° relative to the central longitudinal axis 19. Thus, when the stator 2 is turned round, the inlet serves as the outlet and the outlet is then used as the inlet. In other words, in this embodiment the stator 2 is mirror-symmetrical relative to a diagonal axis.

The milling gap width S, i.e., the width of the milling chamber 7 between the inside wall 21 of the stator and the rotor wall 11, is preferably in the range of 20 to 60 mm, particularly preferably in the range 35 to 55 mm, and can in particular be 36 to 45 mm. L denotes the length of the stator's inside wall 21, D the inside diameter of the stator, and d the outer diameter of the rotor 1, disregarding the milling tools 13. The preferred ratio L/D is in the range 2 to 4 or in the range 2.7 to 3.3. The ratio L/S is preferably in the range 15 to 30 or 18 to 25.

Thanks to the symmetrical structure of the components subjected to intense wear, namely, the rotor, the stator and the separating device, damaged or worn components can be turned around with little effort and their useful life, therefore, extended considerably. For this, the rotor assembly is provided with axial clamping means so as to be able to ensure simple and quick fitting and refitting. This makes possible a resource-sparing and economical way of working compared with conventional agitator mills, and ensures sustained operation. Furthermore, it is possible, depending on the wear, to replace only the rotor assembly. Besides greater sustainability, this also allows greeter flexibility in the use of the agitator mill.

Moreover, by exchanging one of the separation rings 12, 22, the separation gap width s can be changed, in a simple manner, and thus adapted to different products or grinding body sizes.

### LIST OF INDEXES

1 Rotor
11 Rotor wall
12 Rotor separation ring
13 Milling tools
14 Rotor hub
15 Tie-rod
19 Rotation axis
2 Stator
21 Inside wall of the stator
22 Stator separation ring
3 Grinding bodies
41 Product inlet
42 Product outlet
51 Coolant inlet (rotor)
52 Coolant outlet (rotor)
61 Coolant inlet (stator)
62 Coolant outlet (stator)
7 Milling chamber
d Outer diameter of the rotor
D Inside diameter of the stator
L Length of the inside wall of the stator
s Separation gap
S Milling gap.

1-15. (canceled)

16. A rotor (1) such that the rotor is of generally cylindrical shape and comprises
a rotor wall (11),
a plurality of tools (13) attached to the rotor wall (11),
a rotor separation ring (12),
a hub (14), and
at least one tie-rod (15),
wherein the rotor wall (11) and the rotor separation ring (12) are clamped onto the hub (14) by the at least one tie-rod (15),
the rotor separation ring (12) is in the form of a rotationally symmetrical hollow cylinder, and
the rotor wall (11) is rotationally symmetrical relative to a rotation axis (19) and is mirror-symmetrical relative to a plane of symmetry perpendicular to the rotation axis (19).

17. The rotor (1) according to claim 16, wherein arrangement of the tools (13) on the rotor wall (11) is rotationally symmetrical relative to the rotation axis (19) and mirror-symmetrical relative to the plane of symmetry.

18. The rotor (1) according to claim 16, wherein the rotor separation ring (12) is made from one of ceramic material, a hardened metal, or a carbide metal.

19. A mill for the treatment of flowable materials, wherein the mill comprises the rotor (1) according to claim 15,
a stator (2) with a stator inside wall (21) and the rotor (1) is arranged inside the stator (2),
a stator separation ring (22),
a product inlet (41), and
a product outlet (42),
wherein a milling chamber (7) is formed between a stator inside wall (21) and the rotor wall (11) such that the material being milled can pass into the milling chamber (7) through the product inlet (41) and out of the milling chamber (7) through the product outlet (42), and
wherein, between the rotor separation ring (12) and the stator separation ring (22) there is formed a gap (s) through which the milled flowable material in the milling chamber (7) passes to the product outlet (42).

20. The mill according to claim 19, wherein the stator separation ring (22) is in the form of a rotationally symmetrical hollow cylinder and is mirror-symmetrical relative to the plane of symmetry.

21. The mill according to claim 19, wherein a lateral surface of the milling chamber (7) is formed by the stator separation ring (22).

22. The mill according to claim 19, wherein the stator separating ring (22) is made from one of a ceramic material, a carbide metal or a hardened metal.

23. The mill according to claim 19, wherein the inside wall (21) of the stator is rotationally symmetrical relative to the rotation axis (19) and mirror-symmetrical relative to the plane of symmetry.

24. The mill according to claim 19, wherein a plurality of milling tools are arranged on the inside wall (21) of the stator, and the arrangement of the milling tools is rotationally symmetrical relative to the rotation axis (19) and mirror-symmetrical relative to the plane of symmetry.

25. The mill according to claim 19, wherein a milling gap width (S) of the milling chamber (7) is between 20 and 60 mm.

26. The mill according to claim 19, wherein a ratio of a length (L) of the stator to an inside diameter of the stator is between 2 and 4, and/or a ratio of the length (L) of the stator to a milling gap width (S) is 15 to 30.

27. The mill according to claim 19, wherein the milling chamber (7) is at least partially filled with grinding bodies (3).

28. A method for servicing a mill according to claim 19, having the following steps:
extracting the rotor (1) from the mill,
separating the rotor wall (11) and the rotor separation ring (12) from the rotor hub (14) by releasing the at least one tie-rod (15),
rotating the rotor wall (11) and/or the rotor separation ring (12) by 180° about a rotation axis that extends perpendicularly to the rotation axis (19),
clamping the rotor wall (11) and the rotor separation ring (12) in their rotated orientation to the hub (14) by the at least one tie-rod (15), in such manner that the side of the hub (14) that was arranged close to the rotor separation ring (12), before the separation step, is again positioned close to the rotor separation ring (12) after the clamping step, and
refitting the rotor (1) back into the mill.

29. The method according to claim 28, such that between the step of refitting and the step of extracting, the method further comprises the following step:
extracting the inside wall (21) of the stator and the stator separation ring (22) from the mill, rotating the inside wall (21) of the stator and/or the stator separation ring (22) by 180° about a rotation axis that extends perpendicularly to the rotation axis (19), and refitting the inside wall (21) of the stator and the stator separation ring (22) in their rotated orientation back into the mill.

30. A stator assembly for use in a mill according to claim 19, wherein the stator assembly comprises a stator (2) and a stator inside wall (21), which are arranged between a cover and an outlet flange, each arranged at opposite sides of the stator assembly and in such manner that the stator inside wall (21) is mirror-symmetrical relative to the plane of symmetry which is perpendicular to the rotation axis (19).

31. A rotor (1) having a generally cylindrical shape, the rotor comprising:
a rotor wall (11),
a plurality of tools (13) attached to the rotor wall (11),
a rotor separation ring (12),
a pair of opposed hubs (14), and
at least one tie-rod (15) for coupling the pair of opposed hubs (14) to one another,
wherein the rotor wall (11) and the rotor separation ring (12) are clamped to the pair of hub (14) by the at least one tie-rod (15),
the rotor separation ring (12) is in the form of a rotationally symmetrical hollow cylinder, and
the rotor wall (11) is rotationally symmetrical relative to a rotation axis (19) and is mirror-symmetrical relative to a plane of symmetry perpendicular to the rotation axis (19).
